(19) United States
(12) Patent Application Publication
(10) Pub. No.: US 2016/0006791 A1
(43) Pub. Date: Jan. 7, 2016

(54) METHOD, SYSTEM AND MOBILE CLIENT FOR TRANSFERRING DATA FILES BETWEEN MOBILE COMMUNICATION DEVICES

(71) Applicant: Imran Amirali Ladiwala, Gurgaon (IN)

(72) Inventor: Imran Amirali Ladiwala, Gurgaon (IN)

(21) Appl. No.: 14/471,902

(22) Filed: Aug. 28, 2014

(30) Foreign Application Priority Data
Jul. 4, 2014 (IN) 1820/DEL/2014

(51) Int. Cl. H04L 29/08

(52) U.S. Cl. CPC H04L 67/06; H04L 67/10; H04L 67/16

(57) ABSTRACT

A method for transferring a data file from a source device to a destination device via a file transfer system comprises identifying, at the source device, a data file for transfer per user requirements and generating, at the source device, a unique parameter comprising a unique identification component having a unique number and a data component having a copy of the selected data file. The method comprises uploading the parameter to the system and selecting a transmission distance indicating a coverage radius for identifying a destination device within the transmission distance. The method comprises identifying a destination device for transmitting the data file and uploading the information relating to the identified destination device at the system such that the unique parameter and selected data files are updated with information relating to the identified destination device. The method comprises transmitting the selected data file to the identified device via the system.

This application claims the benefit of Indian Patent Application No. 1820/DEL/2014, the disclosure of which is incorporated herein by reference.

### FIELD OF THE INVENTION

The present invention generally relates to a method, a system, a mobile client and a computer program product for transferring data files between mobile communication devices.

### BACKGROUND OF THE INVENTION

The following background discussion includes information that may be useful in understanding the present invention. It is not an admission that any of the information provided herein is prior art or relevant to the presently claimed invention, or that any publication specifically or implicitly referenced is prior art.

Mobile phones have become a staple of the information age. Mobile phones permit communication via wireless telecommunications networks, as well as through the Internet and other networks. Consumer demand has pushed mobile phones, like other devices, to become increasingly smaller, more powerful, and capable of more functions, such as email, two-way messaging, navigation, etc.

There is an increasing need to transfer data between mobile phones. Transmission of data between mobile phones over the cellular mobile network via e.g. SMS or MMS is possible. However, the amount and type of data that can be send this way is limited, in particular for SMS, and for MMS there are relatively high charges for sending e.g. a color picture via the network.

There are other ways to transmit data between mobile communication devices such as Infrared, Bluetooth, NFC (Near Field Communication). However, for these technologies to work both the mobile communication devices i.e., sender device and receiver device should be equipped with Infrared or Bluetooth or NFC technologies. Also, these technologies are expensive and the transmission of data is very slow and inaccurate.

Nowadays, cross-platform mobile messaging apps such as WatsApp, Viber, etc, are very popular for sending data between mobile devices. These mobile apps should be downloaded on the mobile devices to function. For transferring data, these mobile apps use the mobile device contacts list to send data files to other mobile apps users. However, these mobile apps do not provide a way to send data to recipients who are not listed on the contact list of the mobile device. Further, these mobile apps do not send data to their recipients based on the GPS location of the recipient device such as in a meeting; the presenter cannot send the presentation to all the attendees within the room without knowing their mobile contact numbers.

Hence, there is a need for overcoming at least the above-mentioned shortcomings in the prior art and providing an improved file transfer system and methods thereof.

### SUMMARY OF THE INVENTION

A method for transferring at least one data file from a source device to at least one destination device via a file transfer system is disclosed. The method comprises the steps of identifying, at the source device, at least one data file to be transferred as per the user requirements and generating, at the source device, a unique parameter comprising a unique identification component having a unique number and a data component having a copy of the selected at least one data file. The method further comprises of uploading the unique parameter to the file transfer system and selecting, at the source device, a transmission distance indicating a coverage radius for identifying at least one destination device located within the selected transmission distance. Based on selecting, the method further comprises of identifying at least one destination device for transmitting the data file and uploading the information relating to identified destination device at the file transfer system such that the unique parameter having the unique number and selected data files are updated with the information relating to identified destination device. The method further comprises of transmitting the selected at least one data file to the identified destination devices via the file transfer system.

A method for transferring at least one data file from a source device to at least one destination device is also disclosed. The method comprises the steps of identifying, at the source device, at least one data file to be transferred as per the user requirements and selecting, at the source device, a transmission distance indicating a coverage radius for selecting destination devices located within the selected transmission distance. Based on the transmission distance provided, the method further comprises of identifying at least one destination device for transmitting the selected data file and generating, at the source device, a unique parameter for each identified destination device. The unique parameter comprises of a unique identification component having a unique number, a destination component having the details of the identified destination devices and a file component having the copy of the selected data file. The method further comprises of transmitting the selected at least one data file to the identified destination devices.

A mobile client for a source device is also disclosed. The mobile client comprises of a data repository for storing data and a processor, selectively in operative communication with the data repository, configured to identify at least one data file to be transferred as per the user requirements and select a transmission distance indicating a coverage radius for selecting destination devices located within the selected transmission distance. The processor further configured to identify at least one destination device for transmitting the data file based on the transmission distance selected and generate a unique parameter for each selected destination device. The unique parameter comprises of a unique identification component having a unique number, a destination component having the details of the selected destination devices and a file component having the copy of the selected data file. The mobile client further comprises of a user interface, selectively in operative communication with the processor, configured to provide a user to select the data files, transmission distance and destination devices.

A mobile client for a destination device is also disclosed. The mobile client is in operative communication with a file transfer system. The mobile client comprises of a data repository for storing data and a processor, selectively in operative communication with the data repository, configured to receive a data file from the file transfer system and store the received data file in the data repository. The mobile client further comprises of a user interface, selectively in operative communication with the processor, configured to display the files to the user.

A file transfer system for transferring at least one data file from a source device to at least one destination device is also disclosed. The file transfer system comprises of a data repository configured to store the data relating to unique parameter received from the source device and a processor configured to extract the at least one data file from the unique parameter and transmit at least one data file to the respective at least one destination device.

A computer program for transferring at least one data file from a source device to at least one destination device is also disclosed. The computer program comprises of code means which when run on source device causes the source device to identify at least one data file to be transferred as per the user requirements; generate a unique parameter comprising a unique identification component having a unique number and a data component having a copy of the selected at least one data file; upload the unique parameter to the file transfer system; select a transmission distance indicating a coverage radius for identifying at least one destination device located within the selected transmission distance; based on the select, identify at least one destination device for transmitting the data file; upload the information relating to identified destination device at the file transfer system such that the unique parameter having the unique number and selected data files are updated with the information relating to identified destination device and transmit the selected at least one data file to the identified destination devices via the file transfer system.

A computer program product is also disclosed. The computer program product comprises of a computer readable code means and a computer program as described above.

### BRIEF DESCRIPTION OF THE DRAWINGS

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates a functional diagram of a network system in accordance with an embodiment of the invention;

FIG. 2 illustrates a schematic diagram of a mobile client in accordance with an embodiment of the present invention;

FIG. 3 illustrates a schematic diagram of a file transfer system in accordance with an embodiment of the present invention;

FIG. 4 illustrates a schematic diagram of the first embodiment in accordance with an embodiment of the present invention;

FIG. 5 illustrates a schematic diagram of the second embodiment in accordance with an embodiment of the present invention;

FIG. 6 illustrates a flowchart showing a method for transferring data files between a source device and at least one destination device in accordance with an embodiment of the present invention;

FIG. 7 illustrates a screenshot of the registration process in accordance with an embodiment of the present invention;

FIG. 8 illustrates a screenshot of the registration process in accordance with an embodiment of the present invention;

FIG. 9 illustrates a screenshot of the registration process in accordance with an embodiment of the present invention;

FIG. 10 illustrates a screenshot of the registration process in accordance with an embodiment of the present invention;

FIG. 11 illustrates a contact card of the mobile client in accordance with an embodiment of the present invention;

FIG. 12 illustrates a menu of the mobile client in accordance with an embodiment of the present invention;

FIG. 13 illustrates a screenshot for transmitting data files to at least one destination devices in accordance with an embodiment of the present invention;

FIG. 14 illustrates a screenshot for transmitting data files to at least one destination devices in accordance with an embodiment of the present invention;

FIG. 15 illustrates a screenshot for transmitting data files to at least one destination devices in accordance with an embodiment of the present invention;

FIG. 16 illustrates a screenshot for transmitting data files to at least one destination devices in accordance with an embodiment of the present invention;

FIG. 17 illustrates a screenshot for transmitting data files to at least one destination devices in accordance with an embodiment of the present invention;

FIG. 18 illustrates a screenshot for transmitting data files to at least one destination devices in accordance with an embodiment of the present invention;

FIG. 19 illustrates a screenshot for transmitting data files to at least one destination devices in accordance with an embodiment of the present invention;

FIG. 20 illustrates a screenshot for transmitting data files to at least one destination devices in accordance with an embodiment of the present invention;

FIG. 21 illustrates a screenshot for receiving data files from the source devices in accordance with an embodiment of the present invention;

FIG. 22 illustrates a screenshot for receiving data files from the source devices in accordance with an embodiment of the present invention;

FIG. 23 illustrates a screenshot for receiving data files from the source devices in accordance with an embodiment of the present invention;

FIG. 24 illustrates a screenshot for receiving data files from the source devices in accordance with an embodiment of the present invention;

FIG. 25 illustrates a screenshot for receiving data files from the source devices in accordance with an embodiment of the present invention;

FIG. 26 illustrates a setting option of the mobile client in accordance with an embodiment of the present invention; and

FIG. 27 illustrates a typical hardware configuration of a computer system, which is representative of a hardware environment for practicing the present invention.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises . . . a” does not, without more constraints, preclude the existence of other devices or other sub-systems or other elements or other structures or additional devices or additional sub-systems or additional elements or additional structures.

Unless otherwise defined, all technical and scientific terms used herein have the same meaning as commonly understood by one of ordinary skill in the art to which this invention belongs. The method, system, mobile client, computer program product and examples provided herein are illustrative only and not intended to be limiting.

Embodiments of the present invention will be described below in detail with reference to the accompanying drawings.

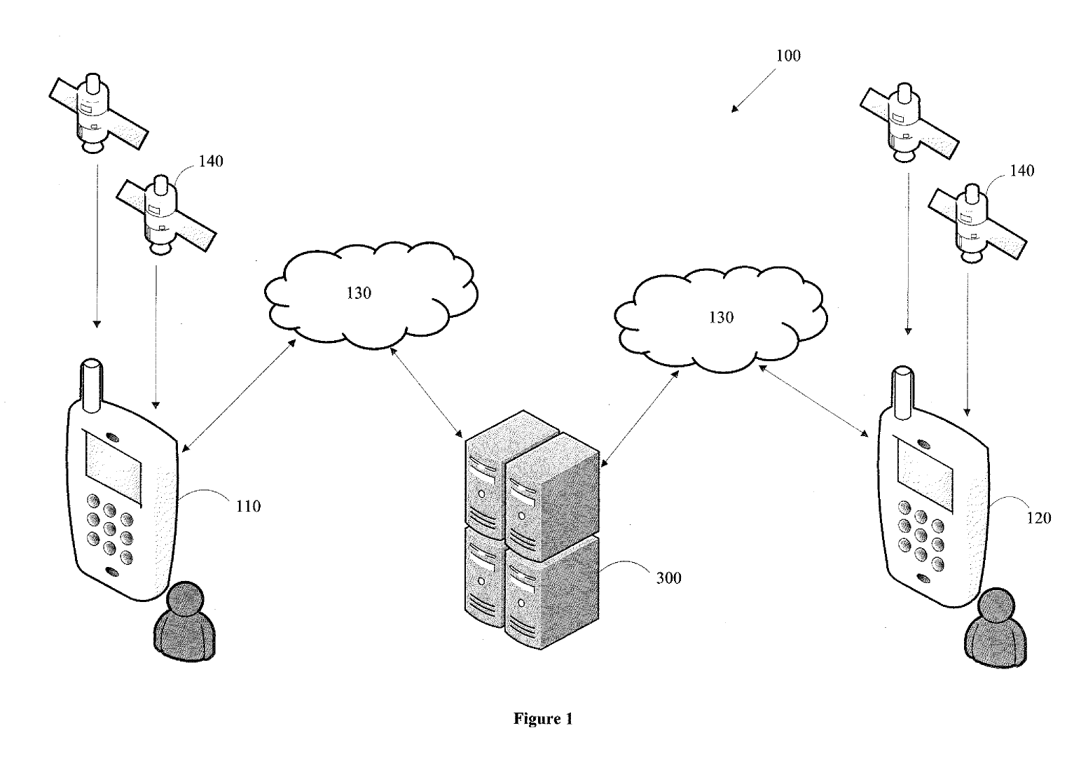

FIG. 1 illustrates a functional diagram of a network system in accordance with an embodiment of the invention. The network system 100 comprises of a file transfer system 300 connected to a source device 110 over a network 130 and connected to a destination device 120 over a network 130. The source device 110 is configured to transmit one or more data files to at least one destination device 120 via the file transfer system 300. In another embodiment, the file transfer system 300 is configured to route the one or more data files to the destination device 120 over the network 130.

The source and destination device 110, 120 may be any device capable of data communication over a wireless communication network such as mobile device, smart phone, a Personal Digital Assistant (PDA) or any other similar device.

In an alternate embodiment, the user device may be a personal computer, a laptop, a palm top or any other computing device. The network may be any wired or wireless communication network such as but not limited to a Local Area Network (LAN), a Wide Area Network (WAN), or so forth.

In a preferred embodiment, the source and destination device 110, 120 are mobile communication devices. In another embodiment, the network 130 is a cellular network or a data network for connecting the file transfer system 300 to source and destination devices of 110, 120.

In another embodiment, the source and destination devices 110, 120 are GPS enabled mobile communication devices. The device 110, 120 may have the GPS capabilities such as maps, including streets maps, displayed in human readable format via text or in a graphical format, turn-by-turn navigation directions to a human in charge of a vehicle or vessel via text or speech, directions fed directly to the vehicle, traffic congestion maps (depicting either historical or real time data) and suggested alternative directions, and information on nearby amenities such as tourist attractions.

The device 110, 120 is in operative communication with the file transfer system 300 and configured to transmit and receive information from the system 300 over the network 130. The device 110, 120 is in operative communication with a plurality of GPS satellites 140 and is configured to receive signals from the plurality of GPS satellites 140.

GPS satellites 150 transmit two low power radio signals, designated L1 and L2. GPS used by civilians uses the L1 frequency of 1575.42 MHz in the UHF band. The GPS signal may contain three different bits of information—a pseudorandom code, ephemeris data and almanac data. The pseudorandom code is simply an I.D. code that identifies which satellite is transmitting information. The Ephemeris data, which is constantly transmitted by each satellite, contains important information about the status of the satellite (healthy or unhealthy), current date and time. This part of the signal is essential for determining a position. The almanac data tells the GPS receiver where each GPS satellite should be at any time throughout the day. Each satellite transmits almanac data showing the orbital information for that satellite and for every other satellite in the system.

The GPS satellites comprises of 24 satellites that make up the GPS space segment are orbiting the earth about 12,000 miles above us. These satellites constantly move, making two complete orbits in less than 24 hours. These satellites are travelling at speeds of roughly 7,000 miles an hour.

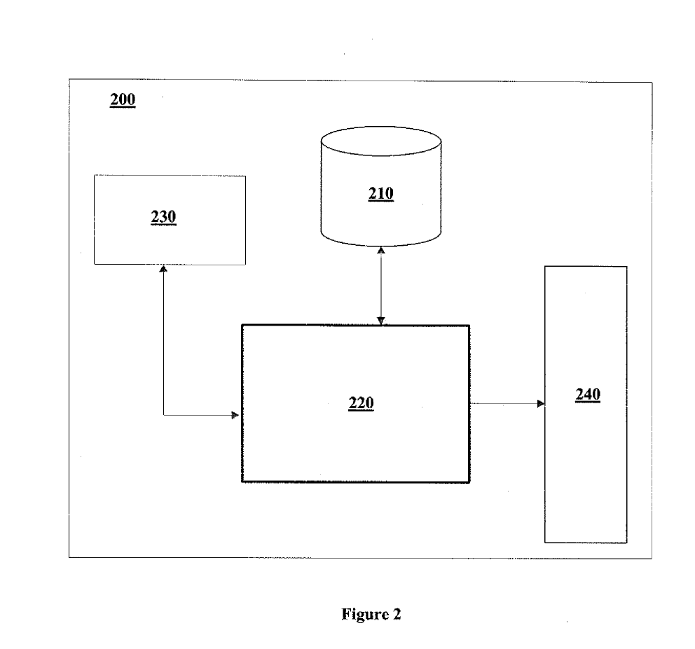

FIG. 2 illustrates a schematic diagram of a mobile client in accordance with an embodiment of the present invention. The mobile client 200 may comprise of a data repository 210, a processor 220, a user interface 230 and a mobile interface 240. According to a preferred embodiment, the mobile client is a mobile application or commonly termed as ‘mobile app’.

The data repository 210, the user interface 230 and the mobile interface 240 are controlled by the processor 220. The mobile client may be directly connected to the file transfer system 300.

The mobile client may be present on the mobile communication device of the user or reside in a SIM card. The mobile client is directly linked to the file transfer system or any other upgrade server for upgrades, alerts and processing of the data files. In accordance with an embodiment, the source and destination device of the user is equipped with a mobile client and adapted to receive and display data contents such as applets, menus, etc. The mobile client may be an application software or dynamic menus built specifically for mobile communication devices. The mobile client may be downloaded from the World Wide Web or may be provided as functionality on the SIM card or can be pushed by a server onto the mobile device of the user.

In accordance with an aspect, the mobile client is a small mobile application and may be easily stored on the SIM card or the storage area of the mobile device and may be provided with interfaces for the operating system of the mobile device.

The mobile client enables seamless communication between the mobile device and the file transfer system regardless of underlying communications protocols. The file transfer system or a push server can identify mobile device capabilities and can cause data contents to be adapted to accommodate display and input limitations of mobile device.

The processor 220 is selectively in operative communication with the data repository and configured to identify at least one data file to be transferred as per the user requirements. The processor is further configured to select a transmission distance indicating a coverage radius for selecting destination devices located within the selected transmission distance. According to a preferred embodiment, the maximum limit of coverage radius is 500 meters. The processor may search for devices within the specified coverage area through GPS technology of the mobile device.

According to an embodiment of the invention, the processor 220 identifies the location coordinates of the source device 110 and based upon the transmission distance provided, searches the respective destination devices 120 from the location coordinates of the source device 110. The location coordinates may be the latitude and longitude of the location of the source device 110.

The processor 220 is further configured to identify at least one destination device for transmitting the data file based on the transmission distance selected. The identification may list one or more destination devices to which the data files may be transferred.

In order to transfer the file to selected destination devices, the processor 220 generates a unique parameter for each selected destination device. The unique parameter comprises a unique identification component having a unique number, a destination component having the details of the identified destination devices and a file component having the copy of the selected data file.

The processor 220 may be configured to send the file directly to the destination devices or via a server such as file transfer system 300, which is explained later. In accordance with a preferred embodiment, the processor is configured to transmit the unique parameter to the file transfer system 300 for transmitting the data to the selected destination device.

The data repository 210 is selectively in operative communication with the processor 220 and configured to store the data send by the source device. The data may be a unique parameter generated by the processor 220. The unique parameter may comprises of a unique identification component having a unique number, a destination component having the details of the selected destination devices and a file component having the copy of the selected data file. The data repository 210 may contains a table and stores the data in a table format.

The user interface 230 is selectively in operative communication with the processor and configured to provide a user of source device to select the data file, transmission distance and destination devices. In accordance with an preferred embodiment, the user interface is a touch screen display.

In accordance with another preferred embodiment, the mobile client is installed in the source and destination devices. In accordance with another preferred embodiment, the mobile client is in operative communication with a GPS receiver of the source device to receive the location information associated with the destination device. In accordance with another embodiment, the GPS receiver is in operative communication with a plurality of GPS satellites to receive the location information associated with the destination device.

In accordance with another preferred embodiment, the data file includes applications, videos, music, pictures, contacts, documents and other types of resource transfers.

In accordance with a preferred embodiment, the processor 220 of the mobile client is linked to a social networking website such that the user of the source device may logon by using their credentials of the social networking account. In this case, when the user of source device is transferring data files to a user of destination device, the user (source device) credentials gets displayed on the destination device such as Name, when receiving data files. In alternate embodiment, the source device credentials (for e.g., device model number) may also show up when the destination device is receiving data files.

Referring now to the destination device, the destination device is also configured with a mobile client. The mobile client comprises of similar architecture as the mobile client of the source device i.e., the mobile client of destination device comprises of a data repository, processor and a user interface. The processor is configured to receive a data file from the file transfer system and store the received data file in the data repository of the mobile client.

The destination device configured to retrieve the data files from the file transfer system upon authentication of the user of source device such that identity of the user of source device is checked by matching an identifier of the unique parameter at the file transfer system.

Upon receiving the data file, the mobile client is configured to automatically notify the user of the destination device by a pop-up seeking authorization for completing the transfer of data file from the source device. The mobile client is configured to display the status of completion with regard to transfer of data file from the source device. Upon completion of the transfer, the data files are stored in a hard drive of the destination device or may also be stored in the data repository of the mobile client.

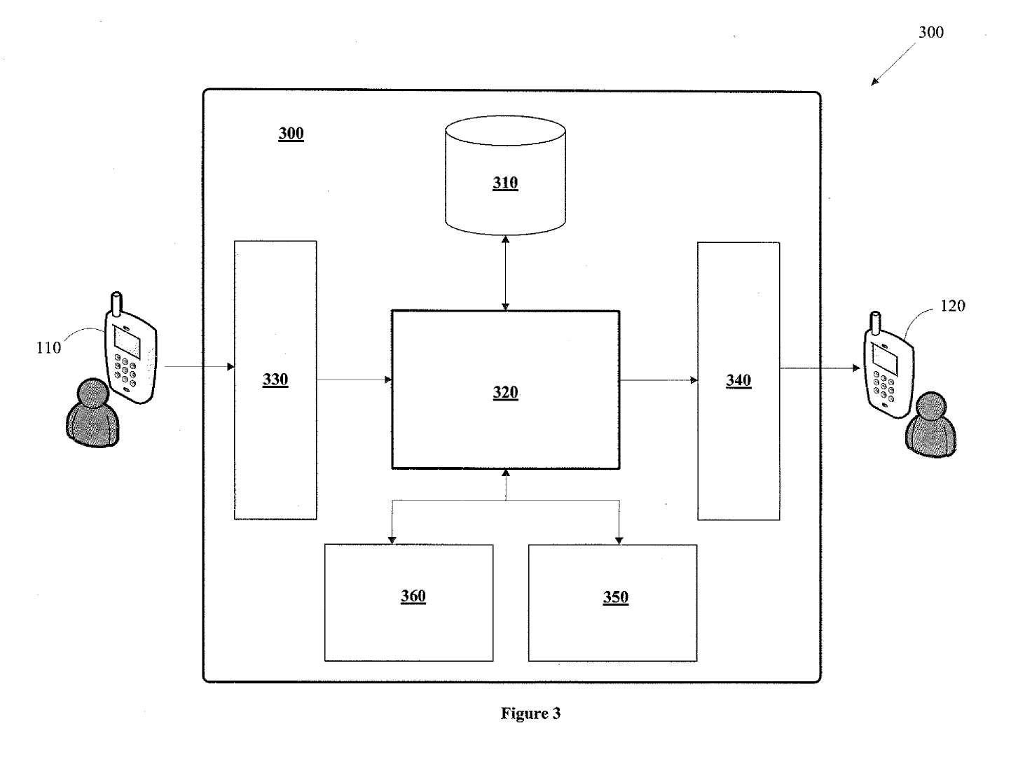

FIG. 3 illustrates a schematic diagram of a file transfer system in accordance with an embodiment of the present invention. The file transfer system 300 is configured to transfer at least one data file from a source device to at least one destination device.

The file transfer system 300 may comprise of a data repository 310, a processor 320, a source mobile interface 330, a destination mobile interface 340, a registration module 350 and a channel integration platform 360. According to a preferred embodiment, the file transfer system is a server or a FTP (File Transfer Protocol) server.

The data repository 310, the source mobile interface 330, the destination mobile interface 340, the registration module 350 and the channel integration platform 360 are controlled by the processor 320.

The data repository 310 is selectively in operative communication with the processor 320 and configured to store the data relating to unique parameter received from the source device. The data repository 310 may contains a table and stores the data in a table format.

The data repository 310 manages two important tables that enables file sharing between the source device and the destination device. These tables are the Batch Table and the Catch Request table.

The batch table keeps track of files that are shared by the source device. Each row will have batch Id, file identifier and location of the source device. The batch table helps to extract files shared as a batch when destination device sends file transfer system a batch Id.

While sharing the files, the source device will first fetch list of potential destination devices at that location. The catch request table helps to identify the potential destination devices at a location. The catch request table may have a Catch ID, User ID, created at and Location attributes. Each row will have use identifier and location coordinates.

The processor 320 is configured to extract the at least one data file from the unique parameter received from the source device and transmit at least one data file to the respective at least one destination device.

The source interface 330 is selectively in operative communication with the processor and configured to communicate with the source device to receive the unique parameter.

The destination interface 340 is selectively in operative communication with the processor and configured to transmit at least one data file to the respective at least one destination device.

The Channel Integration Platform 360 is selectively in operative communication with the processor and configured to perform security related and data integrity related checks on the content of the data files. The Channel Integration Platform may include a security protocol that performs security related and data integrity related checks on the data files. The security protocol may be SSL (Secure Socket Layer), TLS (Transport Layer Security), PPP (Point-to-Point protocol) or any other protocol known in the art.

The registration module 350 is selectively in operative communication with the processor and configured to register new users having a mobile communication device for the data transfer facility.

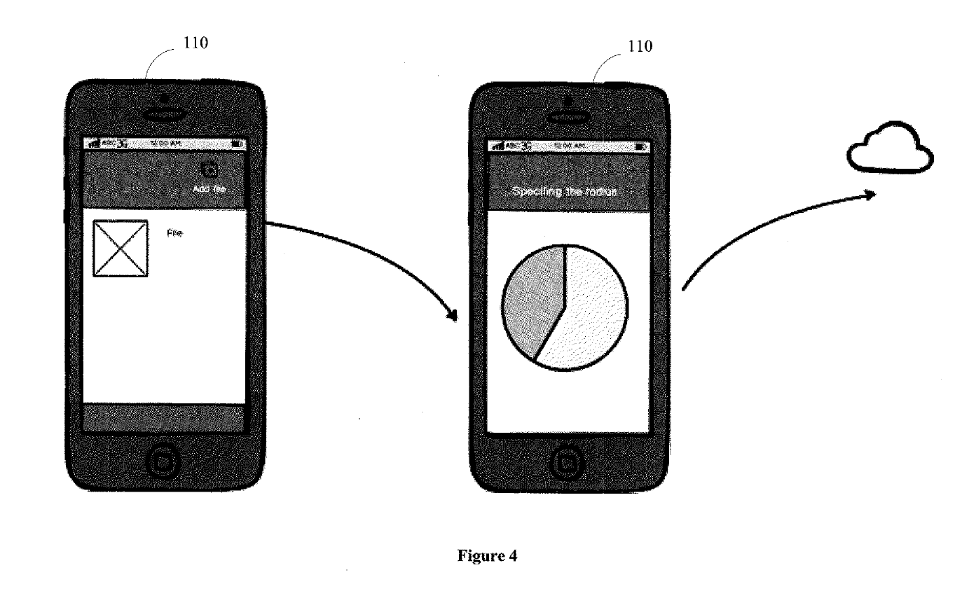

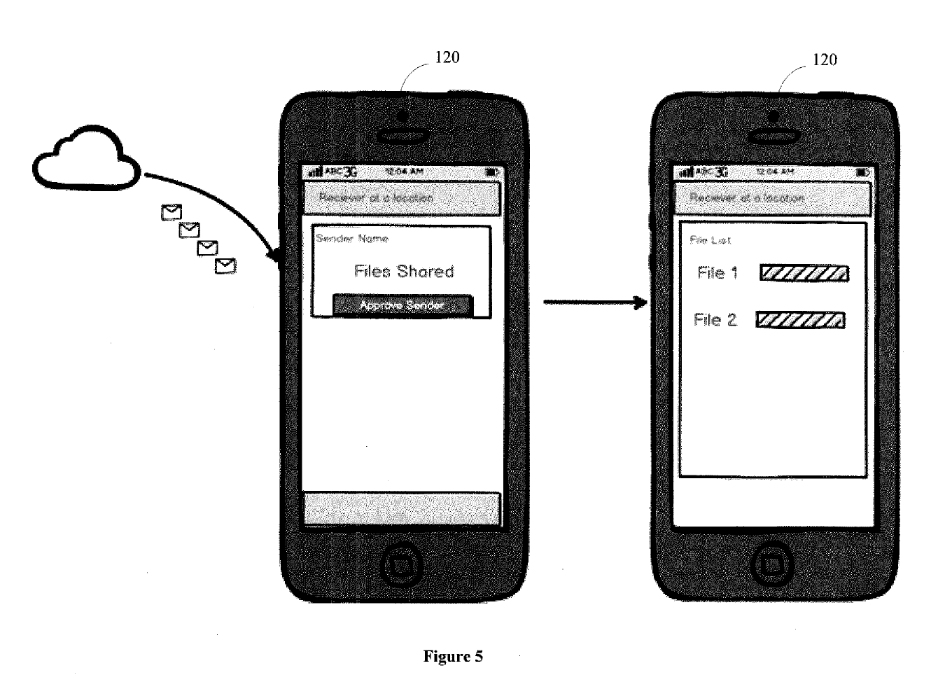

FIGS. 4 and 5 illustrates a schematic diagram of the first embodiment and second embodiment in accordance with an embodiment of the present invention. The first embodiment shows the uploading flow or ‘throw’ flow from the source device and the second embodiment shows the downloading flow or ‘receiver flow’ of the destination device. The mobile client of the source device 110 allows users to transfer or throw files from their current location to one or more destination devices within a specified radius. Once the data file is shared, the destination devices may be intimated through a push notification.

In accordance with a preferred embodiment, the mobile client is driven by a location aware backend server supported on parse. The parse is a mobile backend similar to a service provider. The parse may comprise of an inbuilt file system and location aware data type support for storage. The mobile client uses parse for storing the files shared by source device. All the files shared by source device for each ‘Throw flow’ will constitute a batch. Each batch will be identified at the file transfer system with a unique auto generated batch ids. These batches of files will be tagged with the source device's location. The mobile client uses parse, to deliver notification to destination devices. The notification data will contain source device name and other details along with the id of the batch of files being shared. If the user of the destination device is willing to accept the files shared from a particular source device, a request will be sent to parse to extract list of files in that batch shared. Based on the batch id received from the destination device, the file transfer system lists the files particular to that batch and initiates the downloading for the destination device.

In accordance to another preferred embodiment, the file transfer system lists two important tables that manage the file sharing between the source device and the destination device. These tables are the Batch Table and the Catch Request table.

The batch table keeps track of files that are shared in ‘throw flow’. Each row will have batch Id, file identifier and location of the source device. The batch table helps to extract files shared as a batch when destination device sends file transfer system a batch Id.

While sharing the files, the source device will first fetch list of potential destination devices at that location. The catch request table helps to identify the potential destination devices at a location. The catch request table may have a Catch ID, User ID, created at and Location attributes. Each row will have use identifier and location coordinates.

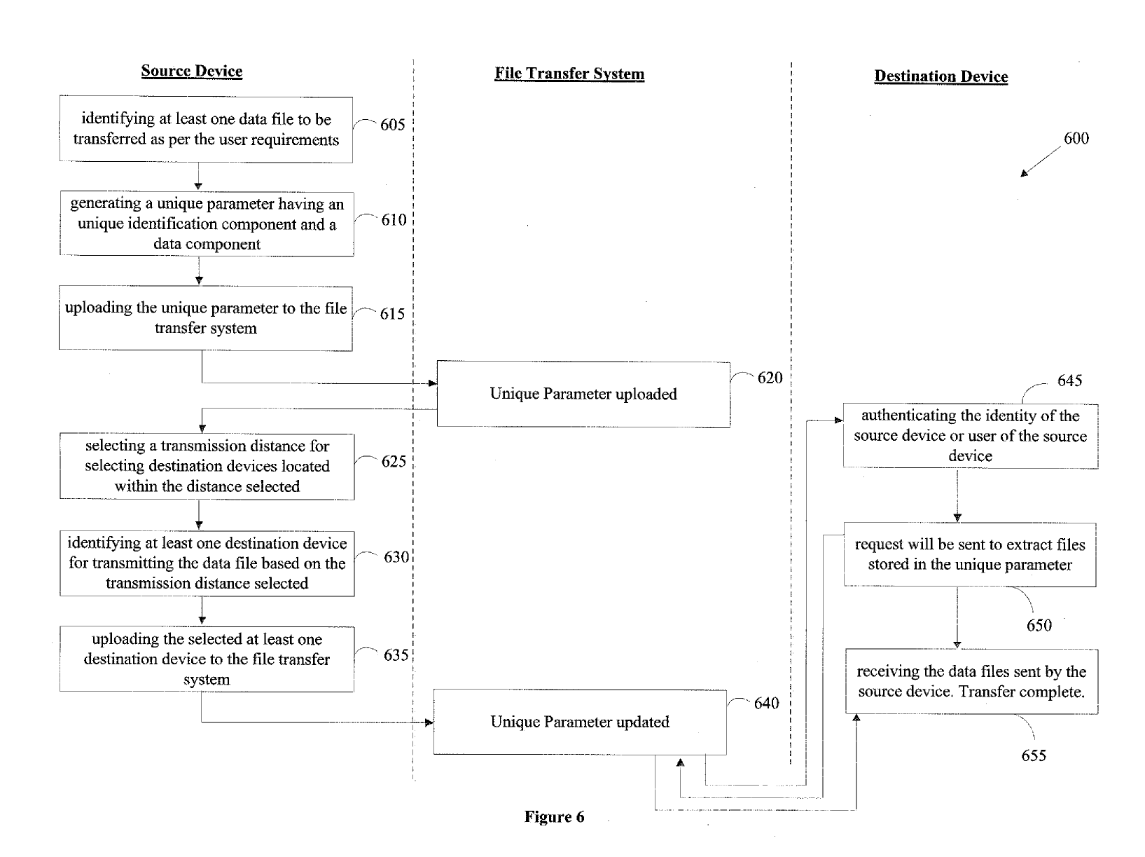

FIG. 6 illustrates a flowchart showing a method for transmitting data files between a source device and at least one destination device in accordance with an embodiment of the present invention. The method comprises the steps of identifying, at the source device, at least one data file to be transferred as per the user requirements, as shown by step 605. The data file is selected from the storage area of the source device. In accordance with a preferred embodiment, the data file may be applications, videos, music, pictures, contacts, documents and other types of resource transfers.

Further, the method comprises of generating, at the source device, a unique parameter having a unique identification component having a unique number and a data component having a copy of the selected at least one data file, as shown by step 610.

Further, the unique parameter is uploaded to the file transfer system and the control is shifted back to the source device after the unique parameter is uploaded to the file transfer system, as shown in step 615 and 620.

Further, the method further comprises of selecting a transmission distance at the source device, as shown by step 625. The transmission distance indicates a coverage radius for selecting destination devices located within the selected transmission distance. According to an embodiment of the invention, the source device identifies its location coordinates and based upon the transmission distance provided, searches the respective destination devices from the location coordinates of the source device. The location coordinates may be the latitude and longitude of the location of the source device.

Further, the method further comprises of identifying at least one destination device for transmitting the data file based on the transmission distance selected, as shown by step 630. This step shows the destination devices having the mobile client within the specified transmission distance. These destination devices should be GPS enabled devices to appear in the search performed by the source device.

Further, the method comprises of uploading the selected destination device information to the file transfer system such that the unique parameter having the unique number and selected data files are updated with the selected at least one destination device information, as shown by step 635. The unique parameter is already stored at the file transfer system at step 620 and is updated with the destination devices information at step 640.

Upon this step, the method transfer control to the selected destination devices. An user interface of the destination device is notified by a pop-up seeking authorization for completing the transfer of data file from the source device. Alternatively, the destination device is notified at their mobile client by a pop-up stating the request for transfer of data file from the source device.

The method further comprise of authenticating the identity of the source device or the user of the source device before accepting the data file, as shown in step 645. Upon authentication of the user of source device, the data files are retrieved from the file transfer system, as shown by step 650. The retrieving includes matching an identifier of the unique parameter created by the source device at the file transfer system. The method shown performs two-fold authentication, firstly the sender of data i.e., user of source device is authenticated such that the user of destination devices accepts his invite to receive file from him. Secondly, the file transfer system shares an identifier with the destination device which is matched after the first authentication is performed.

Further, the method further comprises transmitting the selected at least one data file to the selected destination devices, as shown by step 655. In accordance with a preferred embodiment, the source and destination device are mobile communication device.

In accordance with another preferred embodiment, transmitting includes transferring the selected at least one data file to a mobile client of the selected destination devices. In accordance with another preferred embodiment, logging to the mobile client by a registered social network account such that user (source device) is identified (at the destination device) by the user credentials of the social network account.

A method for transferring at least one data file from a source device to at least one destination device is also shown. The method comprises the steps of identifying, at the source device, at least one data file to be transferred as per the user requirements and selecting, at the source device, a transmission distance indicating a coverage radius for selecting destination devices located within the selected transmission distance. Based on the transmission distance provided, the method further comprises identifying at least one destination device for transferring the selected data file. The method further comprises of generating, at the source device, a unique parameter for each selected destination device. The unique parameter comprises of a unique identification component having a unique number, a destination component having the details of the selected destination devices and a file component having the copy of the selected data file. The method further comprises of transmitting the selected at least one data file to the selected destination devices.

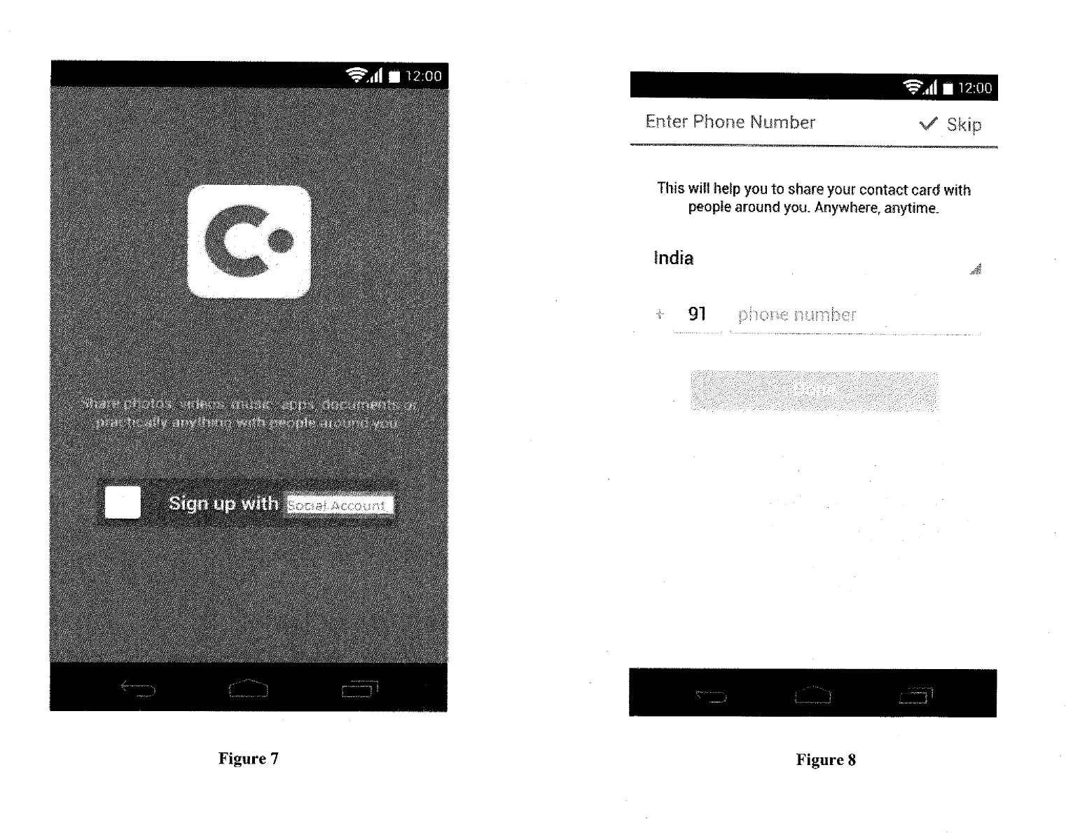

FIG. 7-10 illustrates a screenshot of the registration process in accordance with an embodiment of the present invention. According to an embodiment of the invention, the registration process is triggered by a social networking account. The mobile client seeks the user to login on with the credentials of the social networking account. The mobile client is configured to accommodate social networking accounts such as ‘Facebook’, ‘Twitter’, ‘LinkedIn’, etc.

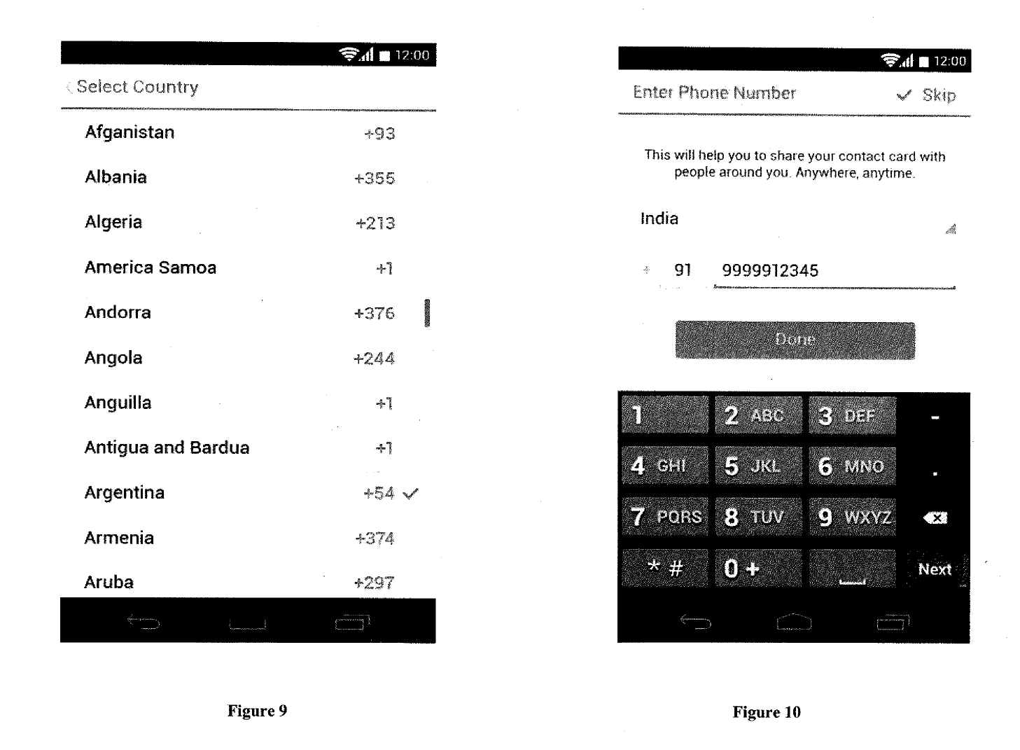

FIG. 7 shows the first page of the mobile client when the user logs on for the first time. FIG. 8 allows the user to select the country of residence and enter the mobile contact number of the device. This would allow the user to share the contact card with other users in the vicinity (as per the coverage radius provided when sharing data). FIG. 9 illustrates the name of the countries and their international dialing codes and FIG. 10 allows the user to finish the registration process by clicking done as illustrated in the said figure.

Alternatively, the mobile client may be configured to accommodate any other conventional registration process available in the art.

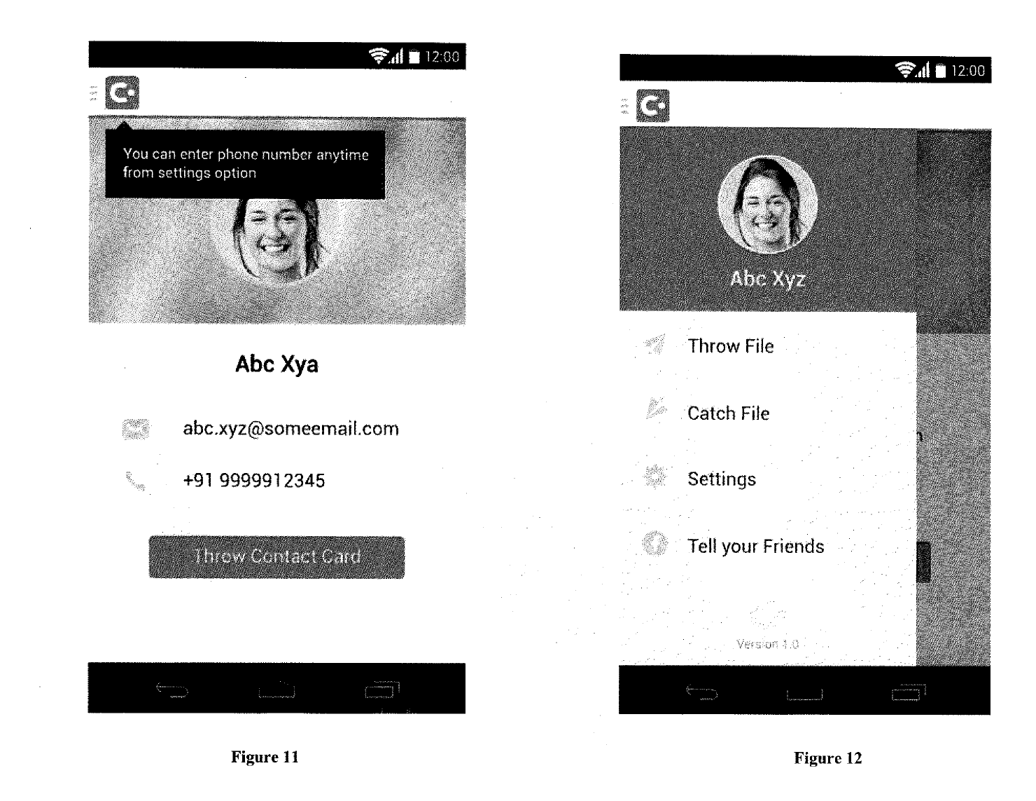

FIG. 11 illustrates a contact card of the mobile client in accordance with an embodiment of the present invention. The contact card may consist of email address and mobile contact details. The contact card also allows the user to send or ‘throw’ contact card to other recipients or destination devices. For example, if a speaker in a conference wants to share his contact details with the audience in a room. The speaker may throw contact card to all the audience in that room without even knowing any details about the audience.

FIG. 12 illustrates a menu of the mobile client in accordance with an embodiment of the present invention. The menu provides the user to send or ‘throw files’, receive or ‘catch files’, settings options and tell your friends option. All the options are explained in detail below.

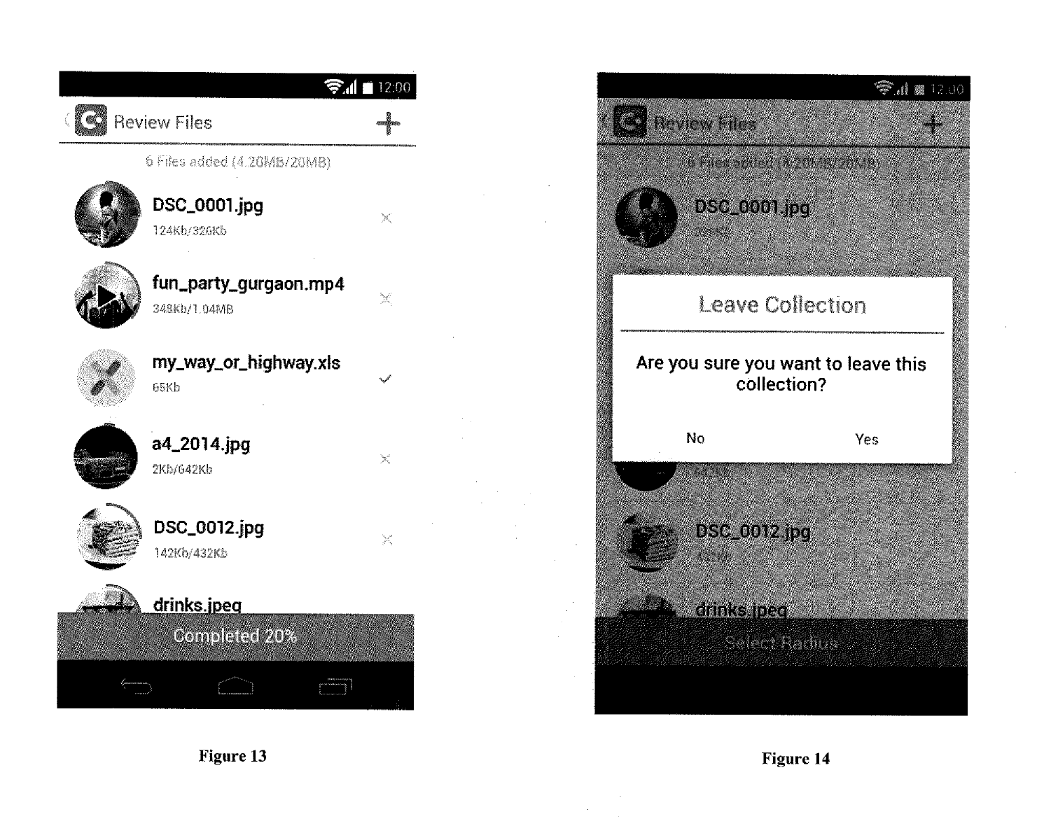

FIG. 13-20 illustrates a screenshot for transmitting data files to at least one destination devices in accordance with an embodiment of the present invention. FIGS. 13 and 14 are triggered when the user selects the ‘throw files’ option from the menu. The option allows the user to select the files from storage space within the source device. The user can select one or more files from the storage area according to their desire. However, there is a restriction of data uploading of 20 MB at every instance. If the user wanted to select data files accumulating over 20 MB, then the user may have to send multiple instances of data files such that every instance is less than 20 MB. Once the data files are selected, the source device uploads the data onto the file transfer system or any server linked with the source device. Upon uploading of data, the mobile clients instruct the user to select radius, which is explained in the next set of figures.

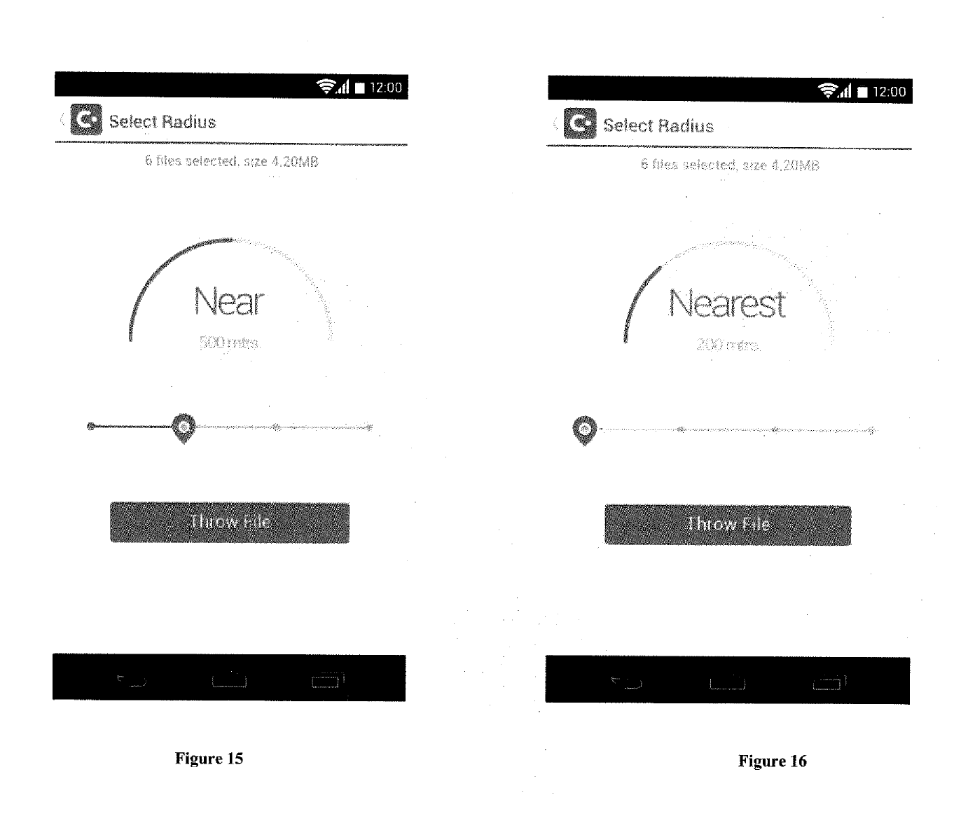

FIGS. 15 and 16 intimates the user to select a transmission distance indicating a coverage radius for selecting destination devices located within the distance selected. The mobile client provides the user with four options: Nearest, Near, Far and Very Far. According to a preferred embodiment, the maximum limit of coverage radius is 500 meters.

The mobile client may search for devices within the specified coverage area through GPS technology of the mobile device. The search will only show those users which have similar mobile client installed on their devices.

The mobile client identifies the location coordinates of the source device and based upon the transmission distance provided, searches the respective destination devices from the location coordinates of the source device. The location coordinates may be the latitude and longitude of the location of the source device. Further, the mobile client allows the user to throw files within selected transmission radius to all the recipients within the area provided.

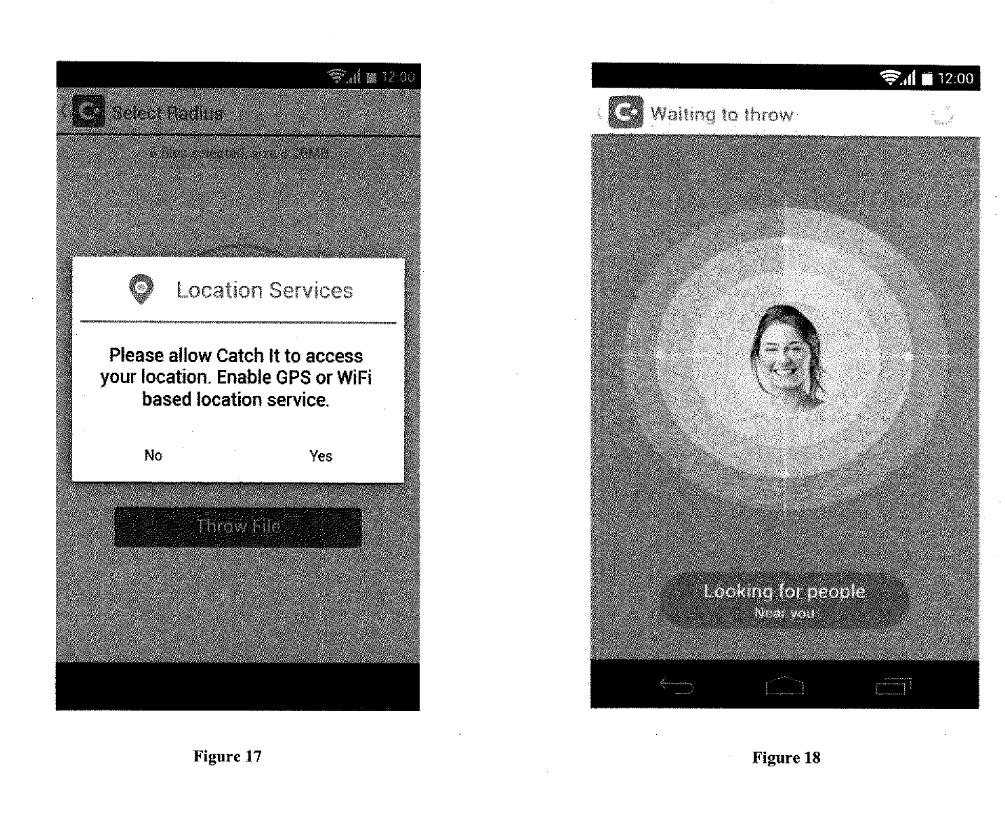

FIG. 17 allows the user to enable the GPS facility of their mobile device. The GPS location is critical to the performance of the mobile client. FIG. 18 shows a screenshot of the mobile client searching for the recipients with the specified transmission radius.

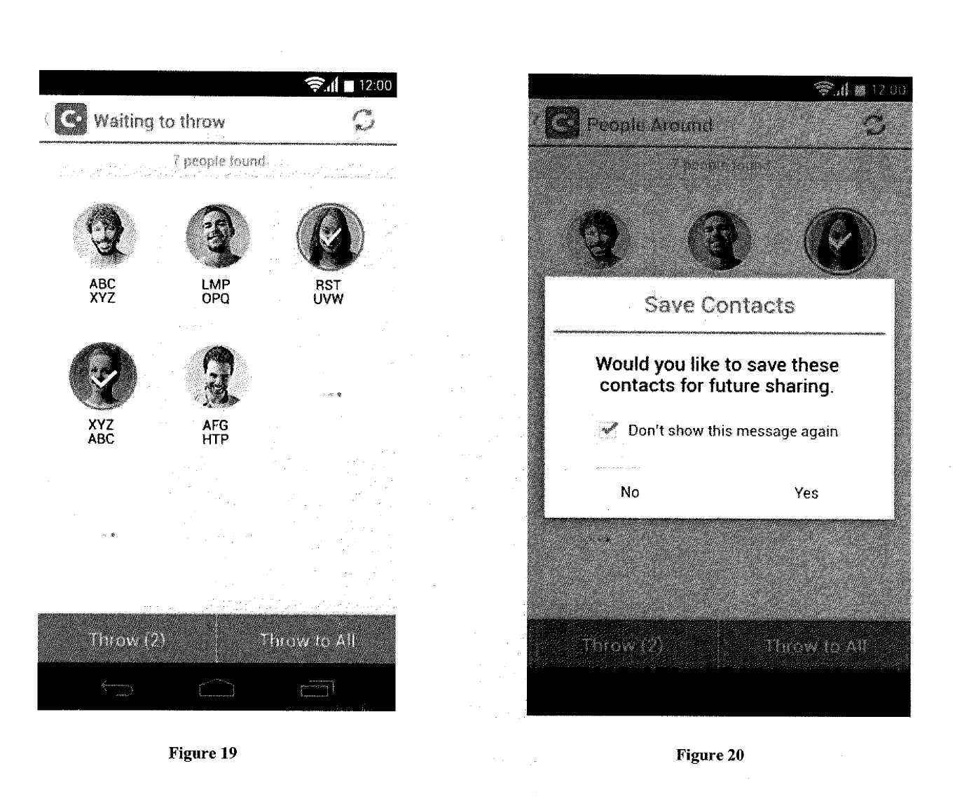

FIG. 19 shows the search results. As per the figure, the search results exhibit the users present in the specified transmission radius. The mobile client provides the user an option to choose/pick the user that he/she wishes to send the data files. The mobile client also provides an option to save the users for future sharing of data, as illustrated in FIG. 20.

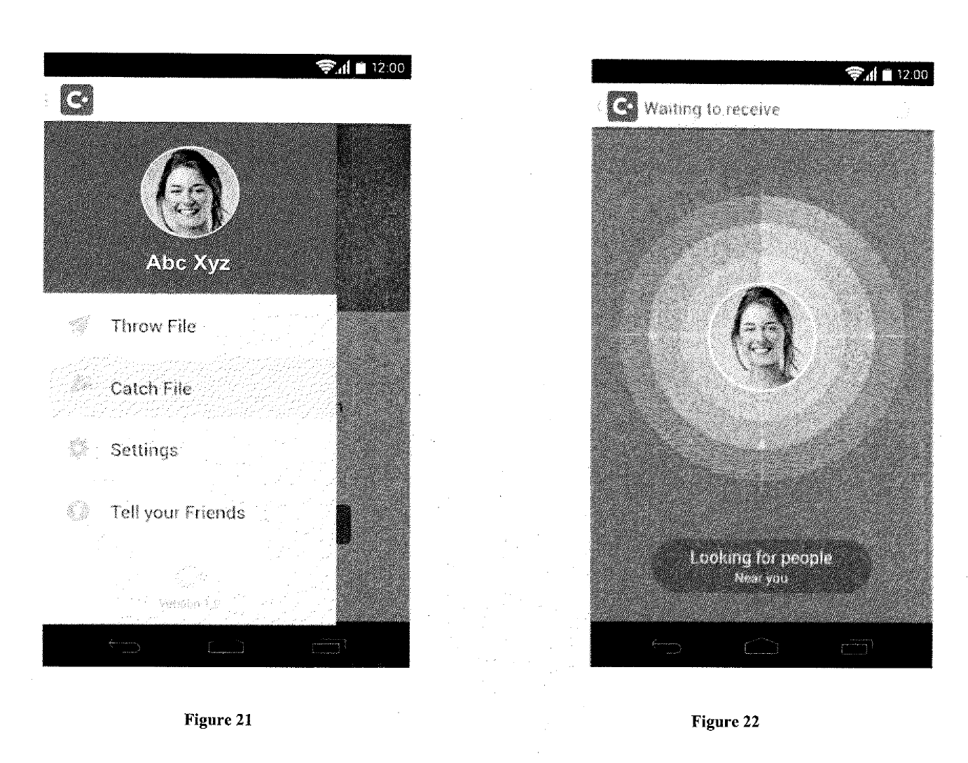

FIG. 21-25 illustrates a screenshot for receiving data files from the source devices in accordance with an embodiment of the present invention.

FIG. 21 illustrates a menu of the mobile client and allows the user to receive file or ‘catch file’. After the user selects the ‘catch file’ option, the mobile client searches for user who may have send files to the user to download, as illustrated in FIG. 22. Alternatively, the mobile client may notify the user by a pop-up seeking authorization for completing the transfer of data file from the source device.

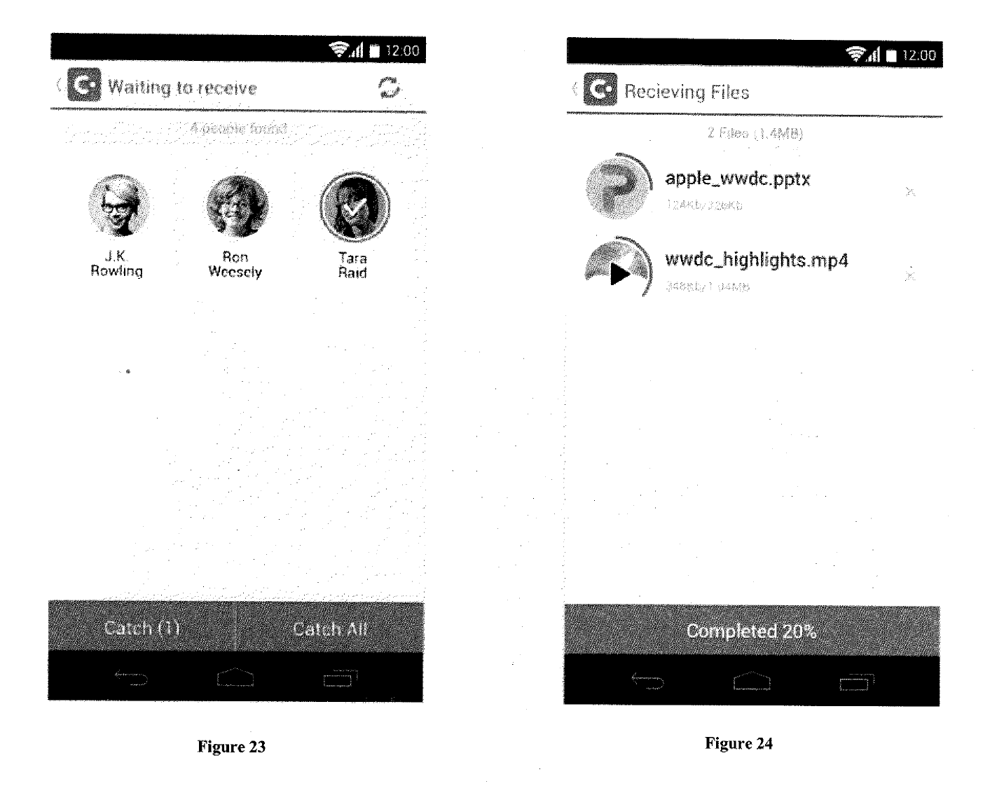

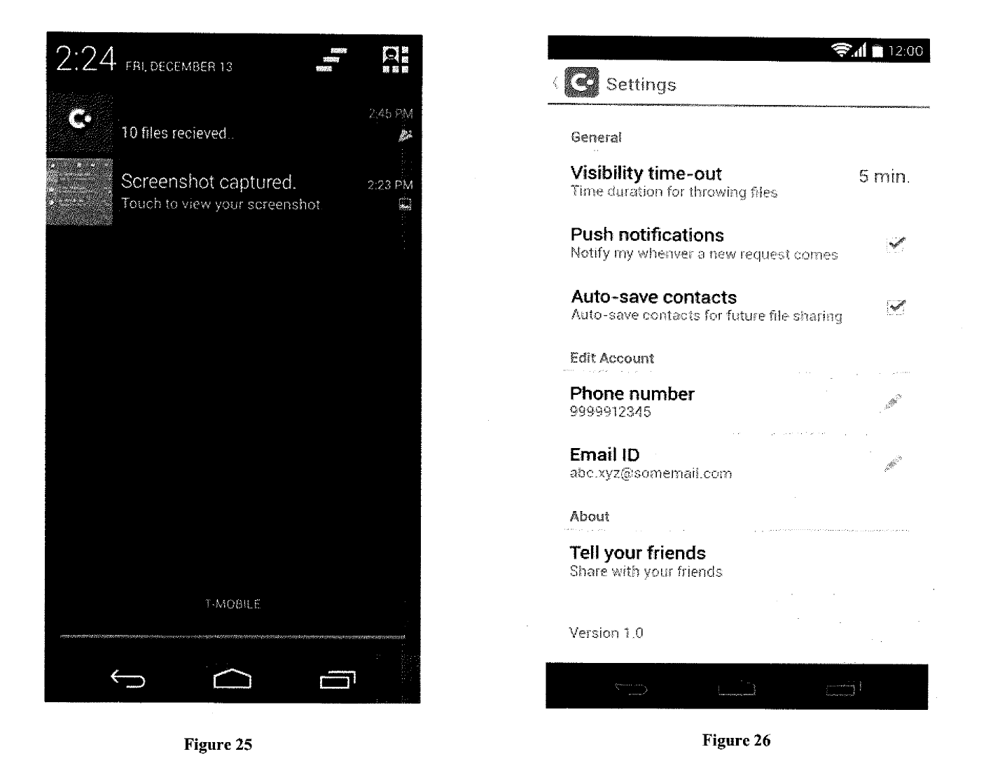

FIG. 23 shows the user with a list of user (source device) who has send files to the user. The mobile client gives the user an option to select all files or select files from a known user. Once the user selects, the mobile client authenticates the identity of the user of the source device before accepting the data file. Upon authentication of the user of source device, the data files are retrieved from the file transfer system or any server where the data files are downloadable. FIG. 24 shows the list of data files being downloaded and the status of download and FIG. 25 shows the user that the data files have been downloaded and the transfer is complete.

FIG. 26 illustrates a setting option of the mobile client in accordance with an embodiment of the present invention. The setting tab provides the user with general setting such as time duration of throwing files, push notifications, auto-save contacts, etc. The setting option also provides the user to amend their email address and mobile contact number.

A computer program for transferring at least one data file from a source device to at least one destination device is also disclosed. The computer program comprises of code means which when run on source device causes the source device to identify at least one data file to be transferred as per the user requirements; generate a unique parameter comprising a unique identification component having a unique number and a data component having a copy of the selected at least one data file; upload the unique parameter to the file transfer system; select a transmission distance indicating a coverage radius for identifying at least one destination device located within the selected transmission distance; based on the select, identify at least one destination device for transmitting the data file; upload the information relating to identified destination device at the file transfer system such that the unique parameter having the unique number and selected data files are updated with the information relating to identified destination device and transmit the selected at least one data file to the identified destination devices via the file transfer system.

A computer program product is also disclosed. The computer program product comprises of a computer readable code means and a computer program as described above.

The invention, as disclosed above, provides one-click identifying and sharing data files between two or more devices. The invention provides sharing of data without knowing the mobile number of the recipients of the data. The invention provides transfer of data file such as applications, videos, music, pictures, contacts, documents and other types of resource transfers. The invention provides free data file transfers between devices with connectivity to no network required. The invention provides a sharing speed 15× faster than 3G and 40× faster than Bluetooth. The invention provides a coverage radius up to 500 meters of distance. Overall, the invention provides a breakthrough way of communication between multiple mobile devices.

The steps of the illustrated method described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

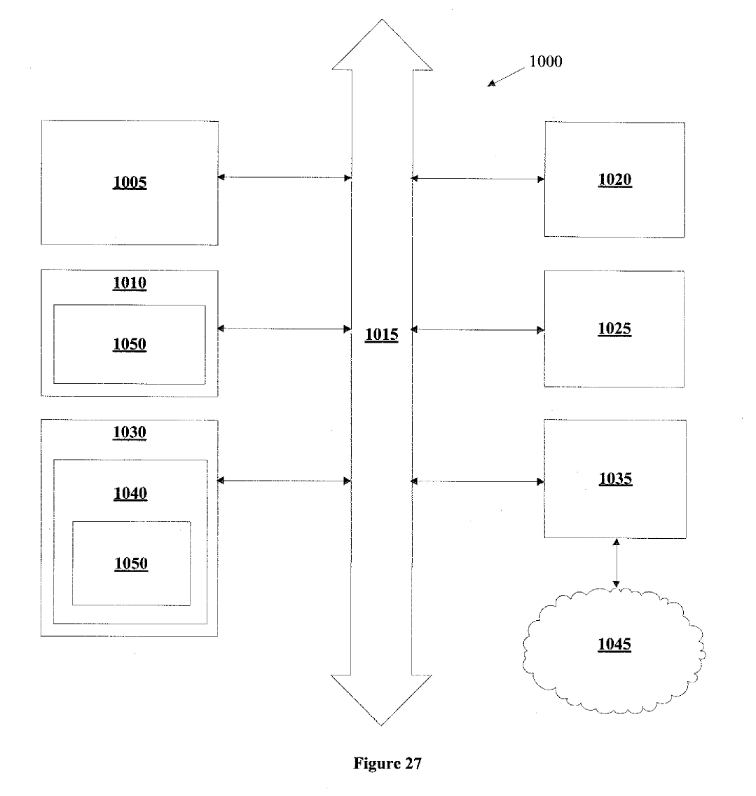

FIG. 27 illustrates a typical hardware configuration of a computer system, which is representative of a hardware environment for practicing the present invention. The computer system 1000 may include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a control system, a camera, a facsimile machine, a printer, a personal trusted device, a web appliance, a network router, switch or bridge, or any other machine capable of executing a set of instructions (sequential or otherwise) that specify actions to be taken by that machine.

Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1005, e.g., a central processing unit (CPU), a graphics processing unit (GPU), or both. The processor 1005 may be a component in a variety of systems. For example, the processor 1005 may be part of a standard personal computer or a workstation. The processor 1005 may be one or more general processors, digital signal processors, application specific integrated circuits, field programmable gate arrays, servers, networks, digital circuits, analog circuits, combinations thereof, or other now known or later developed devices for analyzing and processing data. The processor 1005 may implement a software program, such as code generated manually (i.e., programmed).

The term “module” may be defined to include a plurality of executable modules. As described herein, the modules are defined to include software, hardware or some combination thereof executable by a processor, such as processor 1005. Software modules may include instructions stored in memory, such as memory 1010, or another memory device, that are executable by the processor 1005 or other processor. Hardware modules may include various devices, components, circuits, gates, circuit boards, and the like that are executable, directed, or otherwise controlled for performance by the processor 1005.

The computer system 1000 may include a memory 1010, such as a memory 1010 that can communicate via a bus 1015. The memory 1010 may be a main memory, a static memory, or a dynamic memory. The memory 1010 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1010 includes a cache or random access memory for the processor 1005. In alternative examples, the memory 1010 is separate from the processor 1005, such as a cache memory of a processor, the system memory, or other memory. The memory 1010 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1010 is operable to store instructions executable by the processor 1005. The functions, acts or tasks illustrated in the figures or described may be performed by the programmed processor 1005 executing the instructions stored in the memory 1010. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1020, such as a liquid crystal display (LCD), an organic light emitting diode (OLED), a flat panel display, a solid state display, a cathode ray tube (CRT), a projector, a printer or other now known or later developed display device for outputting determined information. The display 1020 may act as an interface for the user to see the functioning of the processor 1005, or specifically as an interface with the software stored in the memory 1010 or in the drive unit 1030.

Additionally, the computer system 1000 may include an input device 1025 configured to allow a user to interact with any of the components of system 1000. The input device 1025 may be a number pad, a keyboard, or a cursor control device, such as a mouse, or a joystick, touch screen display, remote control or any other device operative to interact with the computer system 1000.

The computer system 1000 may also include a disk or optical drive unit 1030. The disk drive unit 1030 may include a computer-readable medium 1040 in which one or more sets of instructions 1050, e.g. software, can be embedded. Further, the instructions 1050 may embody one or more of the methods or logic as described. In a particular example, the instructions 1050 may reside completely, or at least partially, within the memory 1010 or within the processor 1005 during execution by the computer system 1000. The memory 1010 and the processor 1005 also may include computer-readable media as discussed above.

The present invention contemplates a computer-readable medium that includes instructions 1050 or receives and executes instructions 1050 responsive to a propagated signal so that a device connected to a network 1045 can communicate voice, video, audio, images or any other data over the network 1045. Further, the instructions 1050 may be transmitted or received over the network 1045 via a communication port or interface 1035 or using a bus 1015. The communication port or interface 1035 may be a part of the processor 1005 or may be a separate component. The communication port 1035 may be created in software or may be a physical connection in hardware. The communication port 1035 may be configured to connect with a network 1045, external media, the display 1020, or any other components in system 1000, or combinations thereof. The connection with the network 1045 may be a physical connection, such as a wired Ethernet connection or may be established wirelessly as discussed later. Likewise, the additional connections with other components of the system 1000 may be physical connections or may be established wirelessly. The network 1045 may alternatively be directly connected to the bus 1015.

The network 1045 may include wired networks, wireless networks, Ethernet AVB networks, or combinations thereof. The wireless network may be a cellular telephone network, an 802.11, 802.16, 802.20, 802.1Q or WiMax network. Further, the network 1045 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, and HTTP) may be used. Such standards are periodically superseded by faster or more efficient equivalents having essentially the same functions. Accordingly, replacement standards and protocols having the same or similar functions as those disclosed are considered equivalents thereof.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the apparatus in order to implement the inventive concept as taught herein.

I claim:

1. A method for transferring at least one data file from a source device to at least one destination device via a file transfer system, comprising the steps of:
identifying, at the source device, at least one data file to be transferred as per the user requirements;
generating, at the source device, a unique parameter comprising a unique identification component having a unique number and a data component having a copy of the selected at least one data file;
uploading the unique parameter to the file transfer system;
selecting, at the source device, a transmission distance indicating a coverage radius for identifying at least one destination device located within the selected transmission distance;
based on selecting, identifying at least one destination device for transmitting the data file;
uploading the information relating to identified destination device at the file transfer system such that the unique parameter having the unique number and selected data files are updated with the information relating to identified destination device; and
transmitting the selected at least one data file to the identified destination devices via the file transfer system.

2. The method as claimed in claim 1, wherein transmitting includes transferring the selected at least one data file to a mobile client of the selected destination devices.

3. The method as claimed in claim 1, further comprising notifying a user interface of the destination devices by a pop-up seeking authorization for completing the transfer of data file from the source device.

4. The method as claimed in claim 1, further comprising notifying at the mobile client of the destination devices by a pop-up stating the request for transfer of data file from the source device.

5. The method as claimed in claim 1, further comprising logging to the mobile client by a registered social network account such that user is identified by an user credentials of the social network account.

6. The method as claimed in claim 1, further comprising authenticating, at the destination device, an identity of the source device or the user of the source device before accepting the data file.

7. The method as claimed in claim 1, further comprising retrieving the data files from the file transfer system to the destination device upon authentication of the user of source device such that identity of the user of source device is checked by matching an identifier of the unique parameter at the file transfer system.

8. The method as claimed in claim 1, wherein the source and destination device are mobile communication devices.

9. The method as claimed in claim 1, wherein the data file includes applications, videos, music, pictures, contacts, documents and other types of resource transfers.

10. A method for transferring at least one data file from a source device to at least one destination device, comprising the steps of:
identifying, at the source device, at least one data file to be transferred as per the user requirements;
selecting, at the source device, a transmission distance indicating a coverage radius for selecting destination devices located within the selected transmission distance;
based on the transmission distance provided, identifying at least one destination device for transferring the selected data file;
generating, at the source device, a unique parameter for each identified destination device; the unique parameter comprises a unique identification component having a unique number, a destination component having the details of the identified destination devices and a file component having the copy of the selected data file; and
transmitting the selected at least one data file to the identified destination devices.

11. A mobile client for a source device, comprising:
a data repository for storing data;
a processor, selectively in operative communication with the data repository, configured to identify at least one data file to be transferred as per the user requirements and select a transmission distance indicating a coverage radius for selecting destination devices located within the selected transmission distance; the processor further configured to identify at least one destination device for transmitting the data file based on the transmission distance selected and generate a unique parameter for each selected destination device; the unique parameter comprises a unique identification component having a unique number, a destination component having the details of the selected destination devices and a file component having the copy of the selected data file; and
a user interface, selectively in operative communication with the processor, configured to provide a user to select the data files, transmission distance and destination devices.

12. The mobile client as claimed in claim 11, wherein the processor further configured to transmit the unique parameter to a file transfer system for transmitting the data file to the selected destination device.

13. The mobile client as claimed in claim 11, wherein the mobile client is a mobile application.

14. The mobile client as claimed in claim 11, wherein the source and destination devices are mobile communication devices.

15. The mobile client as claimed in claim 11, wherein the mobile client in operative communication with a GPS receiver of the source device to receive the location information associated with the destination devices.

16. The mobile client as claimed in claim 15, wherein the GPS receiver in operative communication with a plurality of GPS satellites to receive the location information associated with the destination devices.

17. The mobile client as claimed in claim 11, wherein the data file includes applications, videos, music, pictures, contacts, documents and other types of resource transfers.

18. The mobile client as claimed in claim 11, wherein the user interface is a touch screen display.

19. The mobile client as claimed in claim 11, wherein the processor configured to identify a location coordinates of the source device and based upon the transmission distance provided, searches the respective destination devices from the location coordinates of the source device.

20. The mobile client as claimed in claim 19, wherein the location coordinates is the latitude and longitude of the location of the source device.

21. The mobile client as claimed in claim 11, wherein the processor linked to a social networking website such that the user of the source device may logon by using their credentials of the social networking account.

22. The mobile client as claimed in claim 11, wherein the processor configured to display the user's credentials on the destination device when receiving data files from the source device.

23. A mobile client for a destination device in operative communication with a file transfer system, the mobile client comprising:
a data repository for storing data;
a processor, selectively in operative communication with the data repository, configured to receive a data file from the file transfer system and store the received data file in the data repository; and
a user interface, selectively in operative communication with the processor, configured to display the files to the user.

24. The mobile client as claim in claim 23, wherein the processor configured to retrieve the data files from the file transfer system upon authentication of the user of source device such that identity of the user of source device is checked by matching an identifier of the unique parameter at the file transfer system.

25. The mobile client as claim in claim 23, wherein the mobile client configured to automatically notify a user interface of the destination device by a pop-up seeking authorization for completing the transfer of data file from the source device.

26. The mobile client as claim in claim 23, wherein the mobile client configured to display the status of completion with regard to transfer of data file from the source device.

27. A file transfer system for transferring at least one data file from a source device to at least one destination device, comprising:
a data repository configured to store the data relating to unique parameter received from the source device; and
a processor configured to extract the at least one data file from the unique parameter and transmit at least one data file to the respective at least one destination device.

28. The file transfer system as claimed in claim 27, further comprising a source interface, selectively in operative communication with the processor, configured to communicate with the source device to receive the unique parameter.

29. The file transfer system as claimed in claim 27, further comprising a destination interface, selectively in operative communication with the processor, configured to transmit at least one data file to the respective at least one destination device.

30. The file transfer system as claimed in claim 27, further comprising a channel integration platform in operative communication with the processor, configured to perform security related and data integrity related checks on the content of the data files.

31. The file transfer system as claimed in claim 27, further comprising a registration module for registering new users having a mobile communication device.

32. A computer program for transferring at least one data file from a source device to at least one destination device, comprising code means which when run on source device, causes the source device to:
identify at least one data file to be transferred as per the user requirements;
generate a unique parameter comprising a unique identification component having a unique number and a data component having a copy of the selected at least one data file;
upload the unique parameter to the file transfer system;
select a transmission distance indicating a coverage radius for identifying at least one destination device located within the selected transmission distance;
based on the select, identify at least one destination device for transmitting the data file;
upload the information relating to identified destination device at the file transfer system such that the unique parameter having the unique number and selected data files are updated with the information relating to identified destination device; and
transmit the selected at least one data file to the identified destination devices via the file transfer system.

33. A computer program product comprising a computer readable code means and a computer program according to claim 32.
